(19) United States
(12) Patent Application Publication
(10) Pub. No.: US 2005/0128217 A1
(43) Pub. Date: Jun. 16, 2005

(54) Device, system and method for video signal modification

(76) Inventor: Boaz Cohen, Tel-Aviv (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 11/007,278

(22) Filed: Dec. 9, 2004

Related U.S. Application Data
(60) Provisional application No. 60/481,782, filed on Dec. 12, 2003.

(51) Int. Cl. G09G 5/02; G06T 1/00; H04N 11/02; H04N 9/79; H04N 11/00

(52) U.S. Cl. 345/603; 345/600; 345/501; 386/33; 386/34; 348/498

(57) ABSTRACT

Briefly, some embodiments of the invention may provide devices, systems and methods for modifying video signals. In accordance with some embodiments of the invention, a device may include a video adaptor to receive a first video signal having an image rendering code embedded therein, and to produce a second video signal based on the first video signal and the image rendering code.

### PRIOR APPLICATION DATA

This application claims benefit and priority from U.S. Provisional Patent Application No. 60/481,782, entitled “Graphically Invoked RGB-Signal Splitter Method and Apparatus”, filed on Dec. 12, 2003, which is incorporated herein by reference.

### FIELD OF THE INVENTION

The invention relates generally to the field of video signals, and more specifically, to a device, system and method for modifying video signals.

### BACKGROUND OF THE INVENTION

A computing platform, e.g., a desktop computer or a laptop computer, may be used by a presenter as a visual aide during a presentation. For example, while giving a presentation to an audience of viewers, a presenter may operate a Microsoft (RTM) PowerPoint (RTM) presentation using a desktop computer connected to a primary display unit, e.g., a monitor. The computer may also be connected to a secondary display unit, e.g., a relatively larger monitor or a projection screen, on which the presentation may be displayed for viewing by the audience The content displayed on the secondary display unit may be identical to the content displayed on the primary display unit.

Some Microsoft (RTM) Windows (RTM) operating systems have a “dual display” capability, allowing a desktop computer to be connected to a first and second display units, such that a first software application is displayed on the first display unit and a second software application is used on the second display unit Such configuration requires, for example, that two separate video cards be installed in the computer. This requirement may be expensive when using a desktop computer, and may be difficult to satisfy when using some laptop computers which may not support such configuration at all. The “dual display” configuration is dependent on a specific operation system, and may operate only in conjunction with certain software applications that support a “dual display” configuration. Additionally, the “dual display” configuration is a non-mobile solution dependent on a specific hardware system in which the “dual display” is installed.

The “AverKey” computer-to-television converter, available from AverMedia Technologies (www.AverMedia.com), receives a video signal from a computer and performs zoom and screen-freeze operations on the signal before transferring the signal to a television. However, the AverKey needs to be operated using a dedicated hardware control panel, and does not provide a solution to a user that desires to display two different versions of a presentation on two display units, respectively.

NVIDIA Corporation (ww.NVIDIA.com) provides some video cards which support “nView Multi-Display Technology”, allowing a user to arrange a virtual desktop such that some parts of the virtual desktop are displayed on a first display unit and other parts of the virtual desktop are displayed on a second display unit. This configuration lacks versatile and flexibility, requires time for setup and activation, and is dependent on a certain video card and certain software to manage this configuration.

The “eFlash Presenter”, available from Procare International (www.Procare.com.tw), provides a battery-operated unit able to store a presentation and produce a video signal transferred to a display unit. However, this device does not provide a solution to a user that desires to display two different versions of a presentation on two display units, respectively.

### SUMMARY OF THE INVENTION

Some embodiments of the invention may include, for example, a device, system and method for modifying video signals.

Some embodiments of the invention may include, for example, a device, system and method for creating, sending, receiving and utilizing an enhanced video signal carrying video data and image rendering codes.

Some embodiments of the invention may include, for example, a device, system and method to allow displaying a first version of a presentation on a primary display unit and displaying, substantially simultaneously, a modified version of the presentation on a secondary display unit.

Some embodiments of the invention may include, for example, a computing platform to produce a video signal having video data and an image rendering code.

Some embodiments of the invention may include, for example, a video adaptor having a circuit able to receive a first video signal and to produce a second video signal based on an image rendering code included in said first video signal.

Some embodiments of the invention may include, for example, a video adaptor having an input and two or more outputs. The input of the video adaptor may receive a first video signal, e.g., a signal generated by a computing platform. The video adaptor may process the received video signal, and may output one or more video signals using the one or more outputs. For example, in one embodiment, the video adaptor may output the first video signal, substantially unmodified, through the first output, and a second, modified, video signal through the second output. The second, modified, video signal may represent a modification of the first video signal, for example, based on image rendering codes which may be embedded within the first video signal. In some embodiments, the image rendering codes may be included in the first video signal, for example, as graphical or textual elements. The codes may include, for example, an instruction to hide or remove or maintain a pre-selected portion of a video frame, an instruction to hide or remove or maintain portions of a video frame external to a pre-selected portion of a video frame, an instruction to enlarge a pre-selected portion of a video frame, an instruction to remove a portion of a frame which includes a pre-defined texture, an instruction to “freeze” a displayed presentation at a first frame until a second frame is reached, or other instructions to modify one or more video frames.

Some embodiments of the invention may be used, for example, by a presenter to prepare and show a presentation having two versions. A first version may be presented only to the presenter during the presentation, and may include remarks or content that the presenter wishes to see during the presentation and does not wish the audience to see. A second, modified, version of the presentation may be presented to the audience. The second, modified version may include, for example, a content having enlarged or reduced size relative to the first version, a content having a removed or altered portion relative to the first version, or a content having other modifications relative to the first version.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic illustration of a block diagram of a presentation system incorporating a computer, a video adaptor and two display units in accordance with some exemplary embodiments of the invention;

FIG. 2 is a schematic illustration of a block diagram of a presentation system incorporating a computer, a video adaptor and a display unit in accordance with some exemplary embodiments of the invention;

FIG. 3 is a schematic illustration of a block diagram of a video adaptor in accordance with some exemplary embodiments of the invention;

FIG. 4 is a schematic flow-chart of a method of video modification in accordance with an exemplary embodiment of the invention;

FIGS. 5-8 are schematic illustrations of a first video frame as displayed on a primary display unit and a second, modified video frame as displayed substantially simultaneously on a secondary display unit in accordance with some exemplary embodiments of the invention;

FIG. 9 is a schematic illustration of a first series of consecutive frames as displayed on a primary display unit and a second, modified series of consecutive frames as displayed substantially simultaneously on a secondary display unit in accordance with some exemplary embodiments of the invention;

FIGS. 10A-10B are a schematic flow-chart of a method of video modification in accordance with another exemplary embodiment of the invention; and

FIG. 11 is a schematic illustration of a computing platform able to generate an enhanced video signal in accordance with some exemplary embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

It should be understood that embodiments of the invention may be used in a variety of applications. Although the invention is not limited in this respect, embodiments of the invention may be used in conjunction with many apparatuses, for example, a computing platform, a personal computer, a desktop computer, a mobile computer, a laptop computer, a notebook computer, a Personal Digital Assistant (PDA) device, a tablet computer, a server computer, a network, a Local Area Network (LAN), a Wireless LAN (WLAN), a cellular telephone, a wireless phone, a PDA device which incorporates a wireless communication device, a monitor, a display unit, a projector, or the like. It is noted that embodiments of the invention may be used in various other apparatuses, devices, systems and/or networks.

It will be appreciated that the terms “video signal” or “video signals” as used herein may include, for example, video signals and/or video data in accordance with any suitable format, scheme, palette, pantone, resolution, standard and/or protocol, for example, a three-primary-colors standard, a Red-Green-Blue (RGB) standard, a four-colors standard, a Cyan-Magenta-Yellow-Black (CMYK) standard, a Hue-Saturation-Brightness (HSB) scheme, or the like.

It will be appreciated that the term “socket” as used herein may include, for example, any suitable connector, connection, interface, port, terminal, plug, pin, ball, exit socket, entry socket, “in” socket, “out” socket, wired or wireless transmitter socket, wired or wireless receiver socket, wired socket, wireless socket or port, or other connector able to receive or transmit data or signals in a wired or wireless process.

It will be appreciated that the term “link” as used herein may include, for example, one or more cables, wires, connectors, conductors, or the like, and may include a wired and/or wireless link. It will be appreciated that the term “image rendering code” as used herein may include, for example, a code, a command and/or an instruction indicating that a modification may be performed to an image or to a portion of an image or a plurality of images, and/or indicating a property of the modification to be performed, e.g., a type of modification, a location or size of the portion of the image to be modified, or the like.

It will be appreciated that the term “video adaptor” as used herein may include, for example a specific or multi-purpose unit or sub-unit able to perform video modification and/or image rendering in accordance with embodiments of the invention. The term “video adaptor” a used herein may include, for example, a stand-alone or autonomous unit, a Central Processing Unit (CPU), a Digital Signal Processor (DSP), a microprocessor, a plurality of processors, a controller, a chip, a microchip, a circuit, a processing circuit, a sub-circuit, circuitry, a video card, a graphics cards, a graphics acceleration card, or any other suitable multi-purpose or specific processor or controller or circuit.

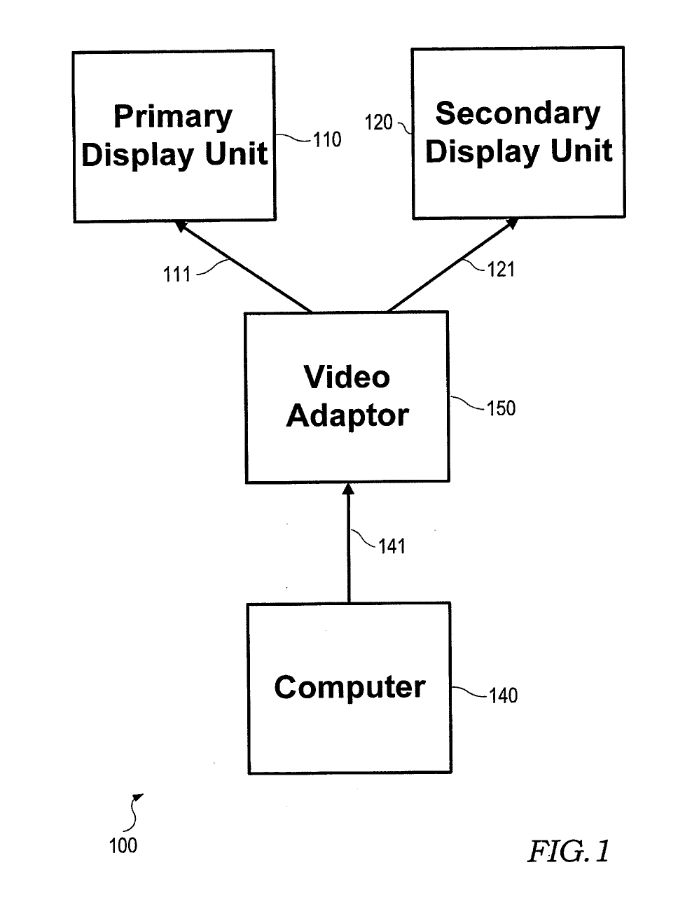

FIG. 1 schematically illustrates a block diagram of a presentation system 100 incorporating a computer, a video adaptor and two display units in accordance with an exemplary embodiment of the invention. System 100 may include, for example, a video adaptor 150 connected to a computer 140 and to a plurality of display units, e.g., a primary display unit 110 and a secondary display unit 120.

Computer 140 may include, for example, a desktop computer or another computing platform or computing device. Primary display unit 110 may include a screen or monitor for locally displaying content produced by computer 140, e.g., to a presenter operating computer 140.

Secondary display unit 120 may include, for example, a screen or monitor for displaying content, e.g., to one or more viewers or an audience of viewers. Secondary display unit 120 may include, for example, a relatively large screen or monitor, or a projector and a screen.

Video adaptor 150 may be connected to computer 140 through a link 141, to primary display unit 110 through a link 111, and to secondary display unit 120 using a link 112. Links 111, 121 and/or 141 may include, for example, a video link, a cable, a wired link, a wireless link, a hardware interface, a plug, a pin, or another suitable connection mechanism.

In accordance with some embodiments of the invention, computer 140 may produce and/or transmit a video signal (“enhanced video signal”) to be received by video adaptor 150. The enhanced video signal may include data in accordance with a standard or format used for representing video content, e.g., RGB data. The enhanced video signal may include embedded data or codes, indicating or corresponding to instructions for processing at least a portion of the enhanced video data in accordance with a pre-defined standard or protocol (“image rendering codes”). Video adaptor 150 may receive the enhanced video signal and may output a first video signal to primary display unit 110 and, substantially simultaneously, a second, different video signal to secondary display unit 120. The first video signal may be substantially identical to the enhanced video signal. The second video signal may include, for example, a result of processing the enhanced video signal by video adaptor 150 based on image rendering codes included in the enhanced video signal.

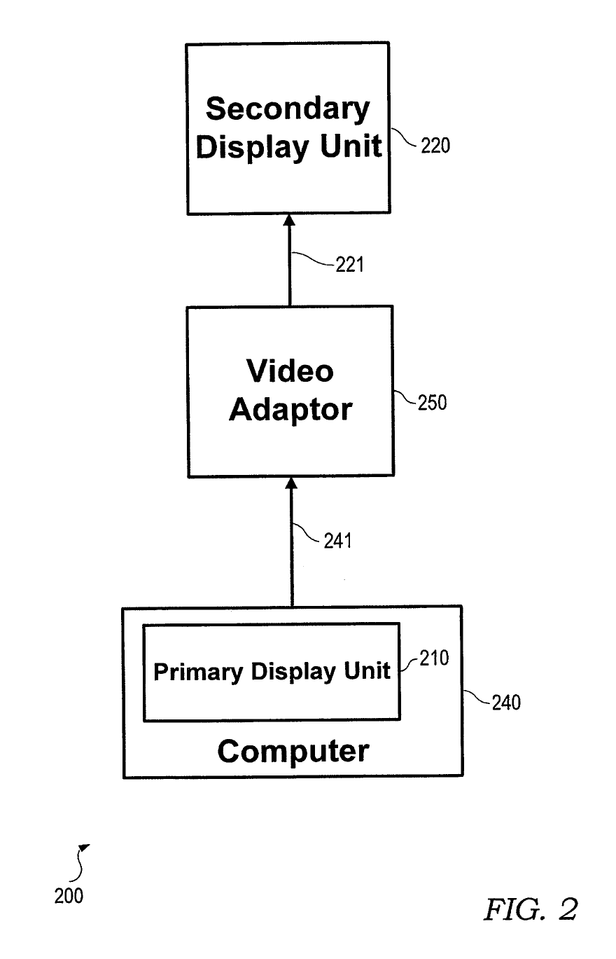

FIG. 2 schematically illustrates a block diagram of a presentation system 200 incorporating a video adaptor and a display unit in accordance with an exemplary embodiment of the invention. System 200 may include, for example, a video adaptor 250 connected to a computer 240, which may include an integrated primary display unit 210, and to a secondary display unit 220.

Computer 240 may include, for example, a laptop computer, a mobile computer, a tablet computer, a PDA device, or another computing platform or computing device. In some embodiments, computer 240 may include, for example, integrated primary display unit 210 for locally displaying content produced by computer 240, e.g., to a presenter operating computer 240. Secondary display unit 220 may include, for example, a screen or monitor for displaying content, e.g., to one or more viewers or an audience of viewers. External display unit 220 may include, for example, a relatively large screen or monitor, or a projector and a projection screen. Video adaptor 250 may be connected to computer 240 through a link 241, and to secondary display unit 220 using a link 221. Links 241 and/or 221 may include, for example, a video link, a cable, a wired link, a wireless link, a hardware interface, a plug, a pin, or another suitable connection mechanism.

In accordance with some embodiments of the invention, computer 240 may produce an enhanced video signal which may be transferred to primary display unit 210 and to video adaptor 250. Video adaptor 250 may receive the enhanced video signal and may output an adapted video signal to secondary display unit 220. The adapted video signal received by secondary display unit 220 may be different from the enhanced video signal received by integrated display unit 210. The adapted video signal may include, for example, a result of processing the enhanced video signal by video adaptor 250 based on image rendering codes included in the enhanced video signal.

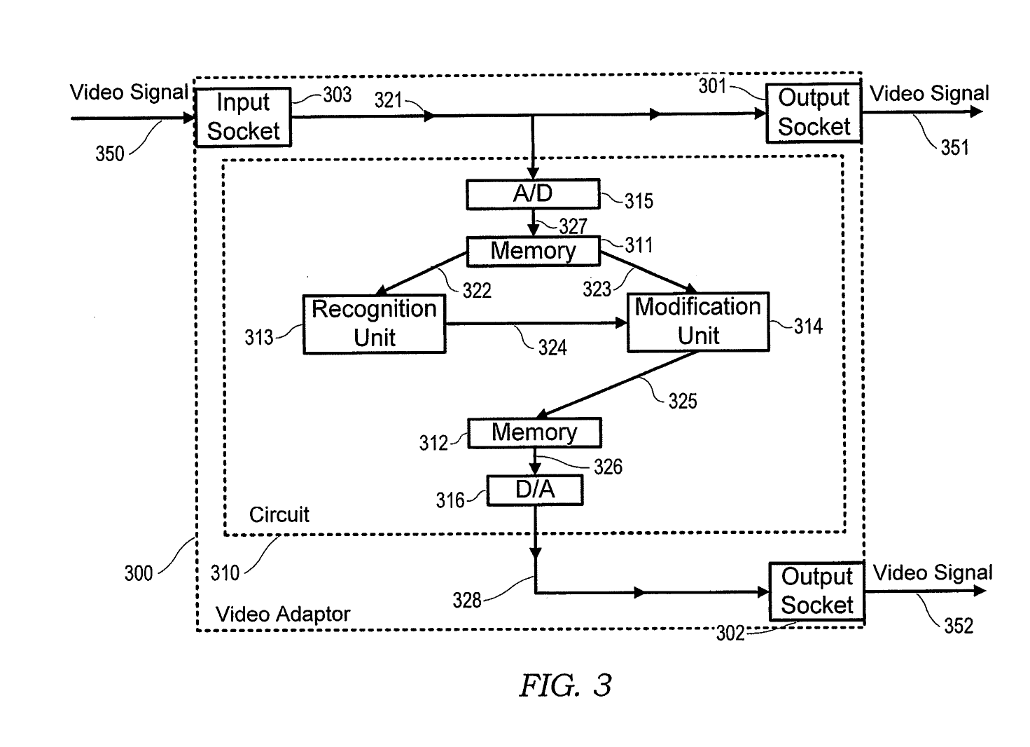

FIG. 3 schematically illustrates a block diagram of a video adaptor 300 in accordance with some exemplary embodiments of the invention. Video adaptor 300 may be an example of video adaptors 150 and/or 250.

Video adaptor 300 may include, for example, an input socket 303, a primary output socket 301, a secondary output socket 302, and a processing circuit 310.

Processing circuit 310 may include, for example, an Analog to Digital (A/D) converter 315, a Digital to Analog (D/A) converter 316, a first memory unit 311, a second memory unit 312, a recognition unit 313, and a modification unit 314.

Memory units 311 and/or 312 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units.

D/A converter 315, A/D converter 316, recognition unit 313 and/or modification unit 314 may include, for example, a Central Processing Unit (CPU), a Digital Signal Processor (DSP), a microprocessor, a host processor, a plurality of processors, a controller, a chip, a microchip, a circuit, circuitry, or any other suitable multi-purpose or specific processor or controller.

In accordance with some embodiments of the invention, input socket 303 may receive an incoming video signal, for example, an enhanced video signal 350 generated by a computer. One or more internal links 321 may transfer the enhanced video signal 350 from input socket 303 to primary output socket 301 and to processing circuit 304. Primary output socket 301 may output a video signal 351 which may be substantially identical to enhanced video signal 350.

Processing circuitry 310 may receive the enhanced video signal 350 through link 321. The enhanced video signal 350 may include, for example, a stream of frames (“enhanced frames”) separated by synchronization pulses. A/D converter 315 may receive an enhanced frame in an analog format, may convert it to a digital format, and may transfer it through internal link 327 for storage in memory unit 311. In some embodiments, memory unit 312 may store a digital representation of one enhanced frame.

Recognition unit 313 and video modification unit 314 may read the enhanced frame stored memory unit 312, for example, through internal links 322 and 323, respectively. Recognition unit 313 may analyze the enhanced frame to identify an image rendering code embedded in the enhanced frame, for example, as a pre-defined graphical or textual element Recognition unit 313 may utilize, for example, one or more pattern recognition algorithms, for example, an algorithm based on principals of multipath search (e.g., similar to cellular communications multipath search algorithms), a histogram comparison algorithm, a histograms analysis algorithm, image matching or partial image matching using measures from connected color regions, image matching or partial image matching using color density analysis and/or maximum co-occurrence color probability analysis, a color reduction algorithm or a color analysis algorithm (e.g., an algorithm by ImageMagick available from www.ImageMagick.com), an image segmentation algorithm used in the field of computer vision, a pixel-based segmentation algorithm of color images, or other suitable algorithms.

In some embodiments, for example, recognition unit 313 may analyze a pre-defined location in the enhanced frame, to detect a certain type of elements, e.g., an element indicating a “freeze” or “de-freeze” as detailed herein. In some embodiments, recognition unit 313 may scan the enhanced frame data and search for a pie-defined shape or size of element. The embedded elements indicating image rendering codes may be represented as, or may correspond to, graphical and/or textual elements.

In some embodiments, for example, an element indicating an image rendering code may include a blue rectangle of ten by five pixels having a red filling inside it. Recognition unit 313 may scan the enhanced frame data and search for this graphical object, for example, by comparing portions of the enhanced frame data with a pre-defined table or list of properties of elements until a match is found. Upon identification of an image rendering code, recognition unit 313 may send a control signal through an internal link 324 to video modification unit 314.

Modification unit 314 may receive the control signal from recognition unit 313 and the enhanced frame from memory unit 311. Video modification unit 314 may apply a suitable modification algorithm to the enhanced frame based on the image rendering code indicated by the control signal, thereby producing a modified frame transferred to memory unit 312 through an internal link 325. The modification algorithm may include, for example, a pixel-by-pixel modification or replacement, a color replacement or modification algorithm, a “zoom-in” or “zoom-out” algorithm, an algorithm for increasing or reducing a size or dimensions of an image or an image portion, or other suitable algorithms.

D/A converter 316 may receive the modified frame from memory unit 312 in a digital format, for example, through an internal link 326. D/A converter 316 may convert the modified frame to an analog format, generating an analog video signal 352 which may be transferred to secondary output socket 302 through an internal link 328. Secondary output socket 302 may output the analog video signal 352, for example, to a secondary display unit.

In some embodiments, memory unit 311 and memory unit 312 may store other suitable data in addition to an enhanced frame and a modified frame, respectively. For example, memory unit 311 may store parameters or data produced or used by modification unit 314 as it modifies a frame.

In some embodiments, one or more components of video adaptor 300 may operate in accordance with a predetermined synchronization scheme, e.g., a predetermined timing or frequency scheme, for example, to allow smooth and/or real-time output of analog video signal 352. For example, if enhanced video signal 350 has a refresh-rate frequency of 60 Hz, then one or more components of processing circuit 310 may also operate in accordance with a frequency of 60 Hz. In some embodiments, for example, if enhanced video signal 350 includes data representing 25 frames per second, then processing circuit 310 may process the data at 25 frames per second. For example, in some exemplary embodiments, A/D converter 315 may convert 25 frames per second, pattern recognition unit 313 may analyze 25 frames per second, modification unit may process and/or modify 25 frames per second, and D/A converter may convert 25 frames per second In some embodiments, one or more optional timing components may be used to achieve such synchronization, for example, a clock, a timer, one or more buffers or delay units, a Phase Locked Loop (PLL), or other suitable components.

In some embodiments, memory unit 311 and/or memory unit 312 may have a storage capacity to store digital data representing substantially one video frame. For example, e.g., in some embodiments utilizing a synchronized operation, digital data may be over-written into memory unit 311 and/or memory unit 312 substantially immediately after previously-stored data is used. It will be appreciated that although part of the discussion herein may relate to video frames, embodiments of the present invention are not limited in this regard. Some embodiments may operate on, for example, a plurality of frames, a set of frames, a stream of video data, or video data arranged in various other formats, e.g., blocks, files, packets, or the like.

It will be appreciated that although part of the discussion herein may relate to a substantially serial frame-by-frame processing, embodiments of the present invention are not limited in this regard. In some embodiments, a plurality of processing circuits or units may operate substantially in parallel, for example, to convert, analyze and/or modify a plurality of frames substantially in parallel and/or substantially simultaneously. Optionally, one or more suitable controllers, processors or memory units may be used, for example, to control or monitor such multi-processing.

It will be appreciated that although FIG. 3 schematically illustrates a plurality of specific components, embodiments of the present invention are not limited in this regard. In some embodiments, two or more components may be integrated into one unit, or one component may be implemented using a plurality of sub-units. In some embodiments, one or more components may be implemented using software components and/or hardware components. It will be appreciated that although a dedicated video adaptor 300 having one input socket and two output sockets is shown, embodiments of the present invention are not limited in this regard. Some embodiments may include, for example, a video adaptor having more than two output sockets, a video adaptor having an input socket integrated with a computer, a video adaptor integrated within a computer, a video adaptor integrated within a video card, a video adaptor integrated within a display unit, a video adaptor implemented as an on-board chip or integrated circuitry, or the like.

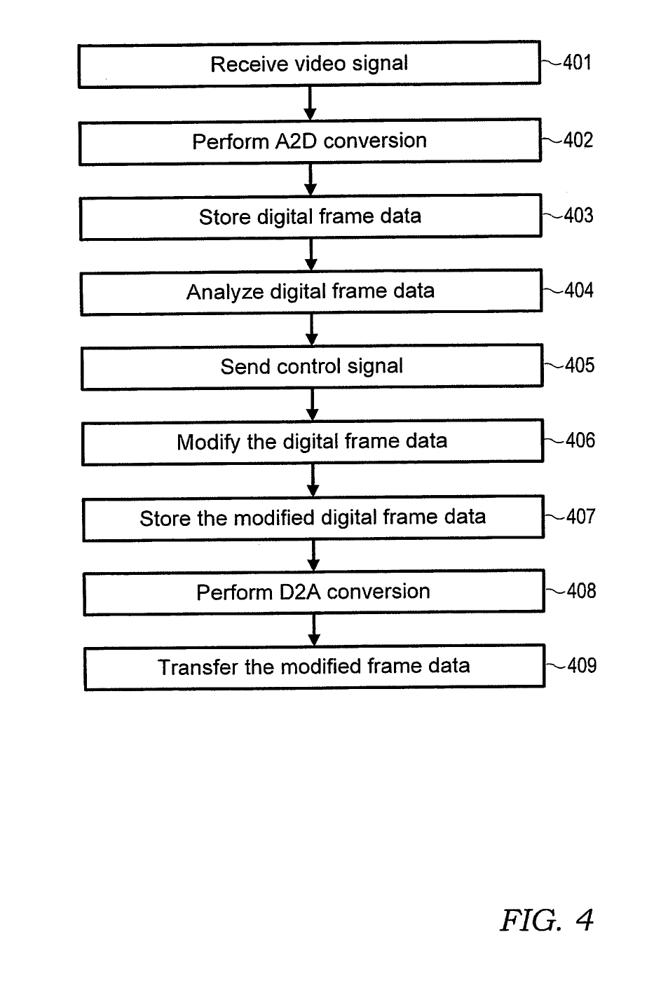

FIG. 4 is a schematic flow-chart of a method of video modification in accordance with exemplary embodiments of the invention. The method may be used, for example, by video adaptor 300, by processing circuit 310, by video adaptor 250, by video adaptor 150, or by other suitable devices or systems.

As indicated at block 401, the method may include, for example, receiving a video signal. In some embodiments, this may include receiving an enhanced video signal generated by a computer. As indicated at block 402, optionally, the method may include converting the video signal from an analog format to a digital format, e.g., using A/D converter 315. As indicated at block 403, the method may include storing digital frame data, representing a frame of the video signal, in memory unit 311.

As indicated at block 404, the method may include analyzing the digital frame data, for example, by recognition unit 313. This may include, for example, detecting an image rendering code embedded in the digital frame data, for example, as a graphical element. As indicated at block 405, the method may include sending a control signal indicating the detected image rendering code, for example, from recognition unit 313 to modification unit 314.

As indicated at block 406, the method may include modifying the digital frame data based on the received control signal. This may be performed, for example, by modification unit 314.

As indicated at block 407, the method may include storing the modified digital frame data, for example, in memory unit 312. Optionally, as indicated at block 408, the method may include converting the frame data from a digital format to an analog format, for example, using D/A converter. Then, as indicated at block 409, the method may include transferring the frame data, for example, to a secondary display unit.

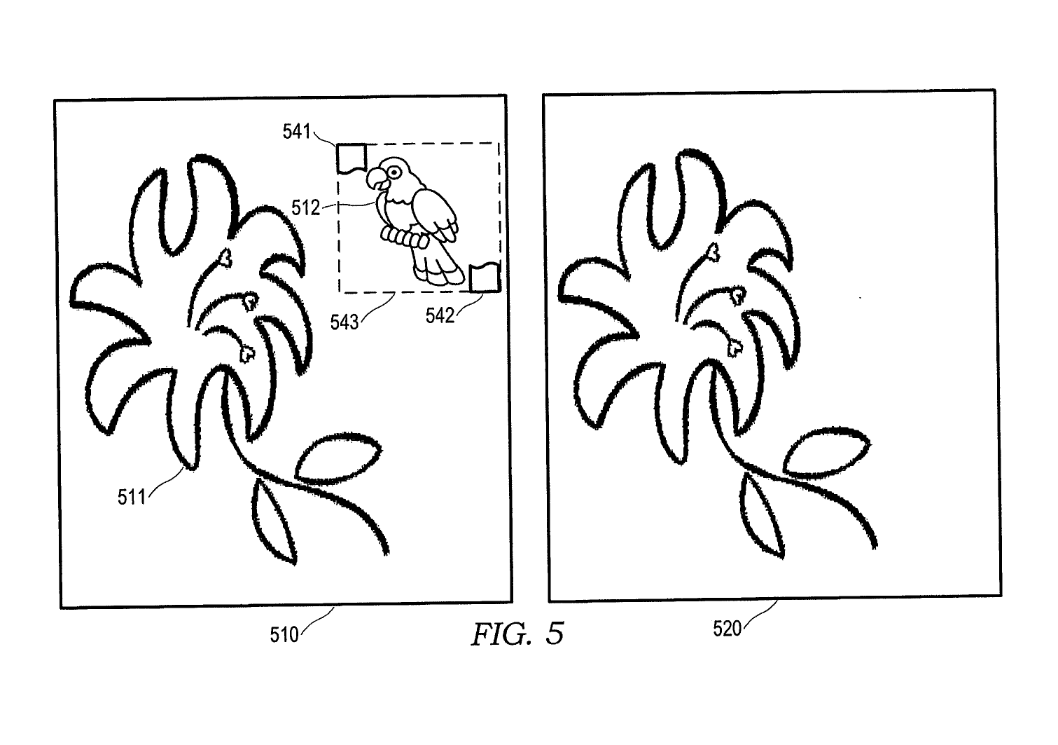

Reference is now made to FIGS. 5-8, which schematically illustrate a first video frame as displayed on primary display unit 110 or 210 and a second, modified video frame as displayed substantially simultaneously on secondary display unit 120 or 220. It will be appreciated that FIGS. 5-8 are presented for exemplary purposes, e.g., to provide visual representation of some exemplary video modification processes, which may be used in accordance with embodiments of the present invention. The scope of the present invention is not limited in this regard, and various other video modification processes may be used.

It will be appreciated that although FIGS. 5-8 schematically illustrate frames having some exemplary objects, the scope of the present invention is not limited in this regard. Embodiments of the invention may be used to process, modify and/or produce various types of video frames, which may include, for example, graphical objects, textual objects, animated objects, moving images or cinematic objects, mathematical formulas, presentations, or the like. Embodiments of the invention are not limited to specific types of video data, video objects, languages, sizes, fonts, or the like.

FIG. 5 schematically illustrates a frame 510 as displayed on primary display unit 110 or 210, and a modified frame 520 as displayed substantially simultaneously on secondary display unit 120 or 220, demonstrating the operation of an “area hideout” video modification in accordance with some embodiments of the invention.

Frame 510 may include one or more portions of video content, for example, a flower 511 and a bird 512. Frame 510 may further include one or more elements, for example, elements 541 and 542, indicating an “area hideout” image rendering code. In some embodiments, the “area hideout” image rendering code may include, for example, an instruction to modify frame 510 by hiding a portion 543 defined by elements 541 and 542, e.g., a rectangular portion 543 whose upper-left corner is element 541 and its lower-right corner is element 542.

An exemplary result of using “area hideout” elements 541 and 542 is shown in a frame 520 as displayed on secondary display unit 120 or 220. Frame 520 includes or maintains flower 511, but does not include bird 520, element 541 and element 542. In some embodiments, instead of displaying bird 512, the area in frame 520 corresponding to portion 543 may display, for example, a white portion, a black portion, a portion having a color similar or identical to the color of the background color of frame 510, a rectangle having a color similar or identical to the most common color of frame 510, a textual or graphical object indicating that a portion of this frame was removed, or the like.

In some embodiments, recognition unit 313 may analyze the frame 510 and may identify the elements 541 and 542. Upon identifying one or more predetermined elements, e.g., elements 541 and 542, unit 313 may send a control signal to processing unit 314. The control signal may indicate, for example, that an “area hideout” instruction was identified, as well as values of one or more parameters which may be used by processing unit 314 to perform the “area hideout” instruction. For example, the control signal may indicate the locations of elements 541 and 542, or parameters defining the location and the size of rectangular portion 543. Modification unit 314 may perform the modification based on the control signal, thereby producing frame 520.

Although two elements 541 and 542 are shown to indicate an “area hideout” instruction, the present invention is not limited in this regard, and other suitable numbers of elements or groups of elements may be used. For example, an optional, third element may be used to indicate a filling color with which the rectangular portion 543 will be filled. In some embodiments, one or more of the elements used may include, for example, data indicating one or more properties to be used when the modification instruction is performed, e.g., data indicating a color-related attribute, a background color attribute, a foreground color attribute, a time-related attribute, or other suitable properties related to the modification.

Although a rectangular portion 543 is shown to indicate the portion 543 to which the “area hideout” instruction relates, the present invention is not limited in this regard, and other suitable portion shapes may be used. For example, a triangular portion 543 may be defined using three specially-shaped elements indicating the three vertices of the triangular portion 543, or a circular portion 543 may be defined using two specially-shaped elements indicating the center of the circular portion 543 and a point in the perimeter of the circular portion 543. In some embodiments, optionally, an additional element may be used to indicate the type of selection shape used, for example, an additional element may be used to indicate whether the shape selected is triangular, circular, rectangular, or the like. In alternate embodiments, the specially-shaped elements defining the dimensions of the selection shape may include an indication of the type of selection shape, for example, using two rectangular-shaped elements may indicate that these elements are used to define two corners of a rectangular portion, and using two circular-shaped elements may indicate that these elements are used to define a center of a circular portion and a point in the perimeter of the circular portion. In some embodiments, a free-shaped portion 543 may be defined, for example, using a contour line of portion 543, e.g., a closed contour line having a pre-defined thickness and/or color and/or texture, a closed contour dotted and/or dashed line in accordance with a pre-defined structure, or the like.

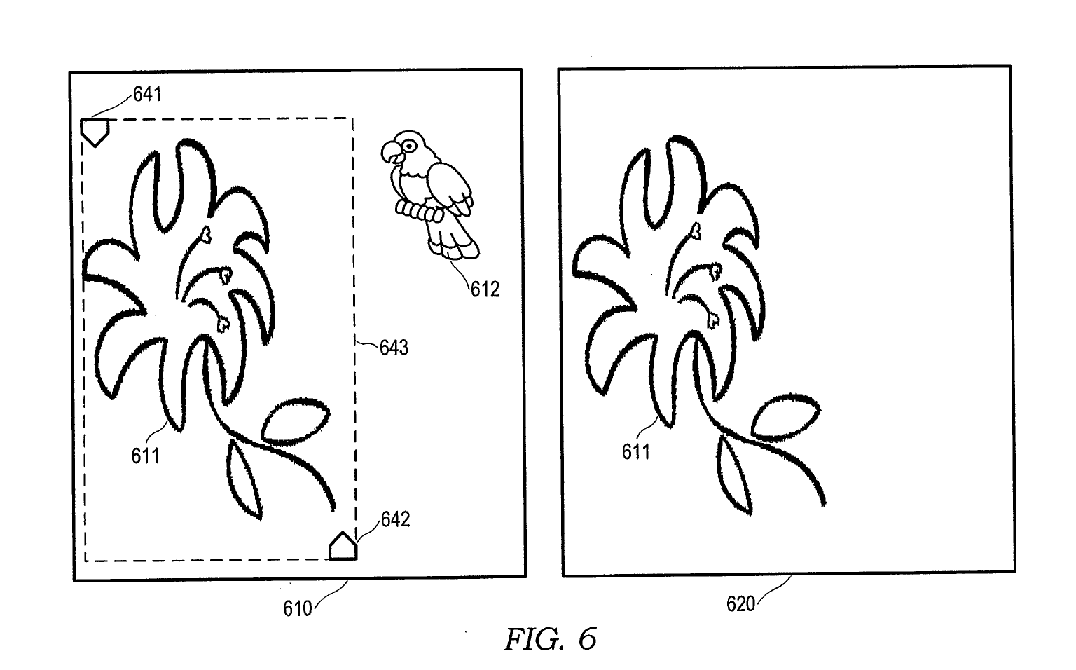

FIG. 6 schematically illustrates a frame 610 as displayed on primary display unit 110 or 210, and a modified frame 620 as displayed substantially simultaneously on secondary display unit 120 or 220, demonstrating the operation of an “area of interest” video modification in accordance with some embodiments of the invention.

Frame 610 may include one or more portions of video content, for example, a flower 611 and a bird 612. Frame 610 may further include one or more elements, for example, elements 641 and 642, indicating an “area of interest” image rendering code. In some embodiments, the “area of interest” image rendering code may include, for example, an instruction to modify frame 610 by hiding substantially all the content of frame 610 external to a portion 643 defined by elements 641 and 642, e.g., a rectangular portion 643 whose upper-left corner is element 641 and its lower-right corner is element 642.

An exemplary result of using “area of interest” elements 641 and 642 is shown in a frame 620 as displayed on secondary display unit 120 or 220. Frame 620 includes or maintains flower 611, but does not include bird 620. In one embodiment, frame 620 may include elements 641 and 642; in an alternate embodiment, frame 620 may not include elements 641 and 642.

In some embodiments, instead of displaying bird 612, an area in frame 620 external to the area corresponding to portion 643 may display, for example, a white color, a black color, a color similar or identical to the background color of frame 610, a color similar or identical to the most common color of frame 610, a textual or graphical object indicating that a portion of frame 620 was removed, or the like.

In some embodiments, recognition unit 313 may analyze the frame 610 and may identify the elements 641 and 642. Upon identifying these elements, recognition unit 313 may send a control signal to processing unit 314. The control signal may indicate, for example, that an “area of interest” instruction was identified, as well as values of one or more parameters which may be used by processing unit 314 to perform the “area of interest” instruction. For example, the control signal may indicate the locations of elements 641 and 642, or parameters defining the location and the size of rectangular portion 643. Modification unit 314 may perform the modification based on the control signal, thereby producing frame 620.

Although two elements 641 and 642 are shown to indicate an “area of interest” instruction, the present invention is not limited in this regard, and other suitable numbers of elements or groups of elements may be used. For example, an optional, third element may be used to indicate a color for filling the area external to portion 643. In some embodiments, one or more of the elements used may include, for example, data indicating one or more properties to be used when the modification instruction is performed, e.g., data indicating a color-related attribute, a background color attribute, a foreground color attribute, a time-related attribute, or other suitable properties related to the modification.

Although a rectangular portion 643 is shown to indicate the portion 643 to which the “area of interest” instruction relates, the present invention is not limited in this regard, and other suitable portion shapes may be used. For example, a triangular portion 643 may be defined using three specially-shaped elements indicating the three vertices of the triangular portion 643, or a circular portion 643 may be defined using two specially-shaped elements indicating the center of the circular portion 643 and a point in the perimeter of the circular portion 643. In some embodiments, optionally, an additional element may be used to indicate the type of selection shape used, for example, an additional element may be used to indicate whether the shape selected is triangular, circular, rectangular, or the like. In alternate embodiments, the specially-shaped elements defining the dimensions of the selection shape may include an indication of the type of selection shape, for example, using two rectangular-shaped elements may indicate that these elements are used to define two corners of a rectangular portion, and using two circular-shaped elements may indicate that these elements are used to define a center of a circular portion and a point in the perimeter of the circular portion. In some embodiments, a free-shaped portion 643 may be defined, for example, using a contour line of portion 643, e.g., a closed contour line having a pre-defined thickness and/or color and/or texture, a closed contour dotted and/or dashed line in accordance with a pre-defined structure, or the like.

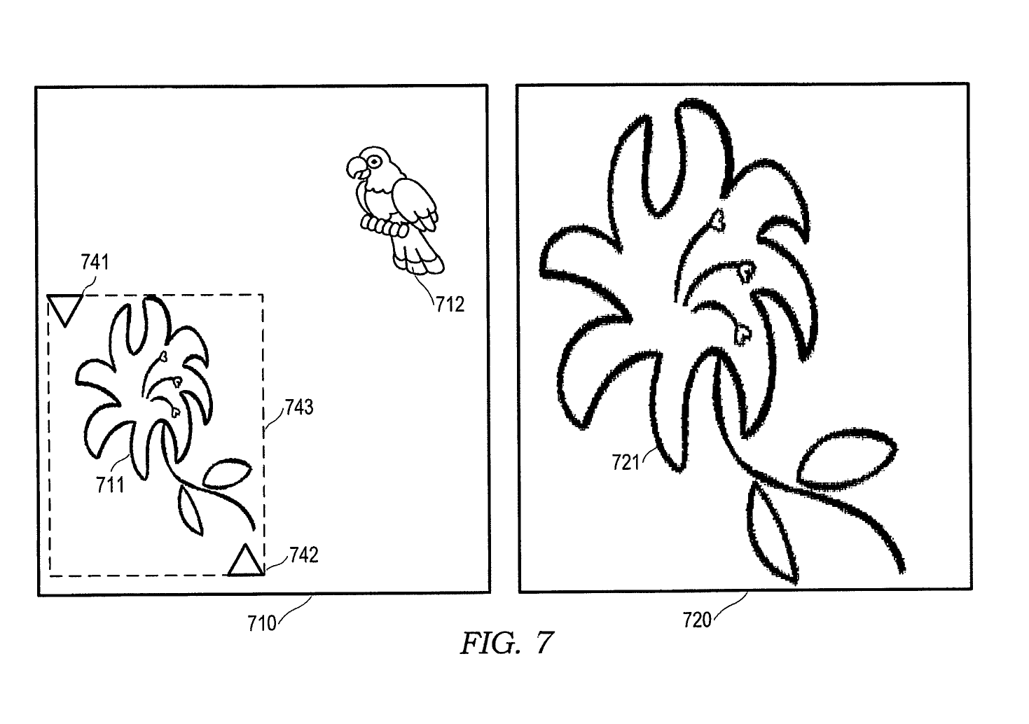

FIG. 7 schematically illustrates a frame 710 as displayed on primary display unit 110 or 210, and a modified frame 720 as displayed substantially simultaneously on secondary display unit 120 or 220, demonstrating the operation of an “area blowout” video modification in accordance with some embodiments of the invention.

Frame 710 may include one or more portions of video content, for example, a flower 711 and a bird 712. Frame 710 may further include one or more elements, for example, elements 741 and 742, indicating an “area of interest” image rendering code. In some embodiments, the “area blowout” image rendering code may include, for example, an instruction to modify frame 710 by resizing a portion 743 defined by elements 741 and 742, e.g., a rectangular portion 743 whose upper-left corner is element 741 and its lower-right corner is element 742. The resizing may include, for example, enlarging portion 743 to occupy substantially all the frame area.

An exemplary result of using “area blowout” elements 741 and 742 is shown in a frame 720 as displayed on secondary display unit 120 or 220. Frame 720 includes flower 721 which may be an enlarged copy of flower 711, occupying substantially all the area of frame 720. In one embodiment, frame 720 may include elements 741 and 742; in an alternate embodiment, frame 720 may not include elements 741 and 742.

In some embodiments, recognition unit 313 may analyze the frame 710 and may identify the elements 741 and 742. Upon identifying these elements, recognition unit 313 may send a control signal to processing unit 314. The control signal may indicate, for example, that an “area blowout” instruction was identified, as well as values of one or more parameters which may be used by processing unit 314 to perform the “area blowout” instruction. For example, the control signal may indicate the locations of elements 741 and 742, or parameters defining the location and the size of rectangular portion 743. Modification unit 314 may perform the modification based on the control signal, thereby producing frame 720.

In some embodiments, an “area blowout” instruction may be performed in accordance with a suitable process. For example, in one embodiment, an “area blowout” instruction may be performed so that the portion 743 is enlarged to occupy substantially the entire area of frame 720, even if such enlargement modifies the aspect ratio of portion 743 or results in a partially distorted content. For example, if frame 710 includes an area of 800 by 400 pixels, and portion 743 includes an area of 200 by 200 pixels, then portion 743 may be enlarged to occupy substantially the entire area of 800 by 400 pixels, thereby causing the enlarged flower 721 to appear “stretched” in comparison with the original flower 711.

In an alternate embodiment, an “area blowout” instruction may be performed so that portion 743 is enlarged to occupy a maximum area without modifying the aspect ratio of portion 743. For example, if frame 710 includes an area of 800 by 400 pixels, and portion 743 includes an area of 200 by 200 pixels, then portion 743 may be enlarged by 100 percent to occupy an area of 400 by 400 pixels, thereby enlarging portion 743 while avoiding distortion. In such case, areas in frame 720 not occupied by the enlargement of portion 743 may be filled with a pre-defined color, for example, a white color, a black color, a color similar or identical to the background color of frame 710, a color similar or identical to the most common color of frame 710, a textual or graphical object indicating that a portion of frame 710 was removed, or the like.

Although two elements 741 and 742 are shown to indicate an “area blowout” instruction, the present invention is not limited in this regard, and other suitable numbers of elements or groups of elements may be used. For example, an optional, third element may be used to indicate whether or not the enlargement process should maintain the aspect ratio of portion 743. In some embodiments, one or more of the elements used may include, for example, data indicating one or more properties to be used when the modification instruction is performed, e.g., data indicating a color-related attribute, a background color attribute, a foreground color attribute, a time-related attribute, or other suitable properties related to the modification.

Although a rectangular portion 743 is shown to indicate the portion 743 to which the “area blowout” instruction relates, the present invention is not limited in this regard, and other suitable portion shapes may be used. For example, a triangular portion 743 may be defined using three specially-shaped elements indicating the three vertices of the triangular portion 743, or a circular portion 743 may be defined using two specially-shaped elements indicating the center of the circular portion 743 and a point in the perimeter of the circular portion 743. In some embodiments, optionally, an additional element may be used to indicate the type of selection shape used, for example, an additional element may be used to indicate whether the shape selected is triangular, circular, rectangular, or the like. In alternate embodiments, the specially-shaped elements defining the dimensions of the selection shape may include an indication of the type of selection shape, for example, using two rectangular-shaped elements may indicate that these elements are used to define two corners of a rectangular portion, and using two circular-shaped elements may indicate that these elements are used to define a center of a circular portion and a point in the perimeter of the circular portion. In some embodiments, a free-shaped portion 743 may be defined, for example, using a contour line of portion 743, e.g., a closed contour line having a pre-defined thickness and/or color and/or texture, a closed contour dotted and/or dashed line in accordance with a pre-defined structure, or the like.

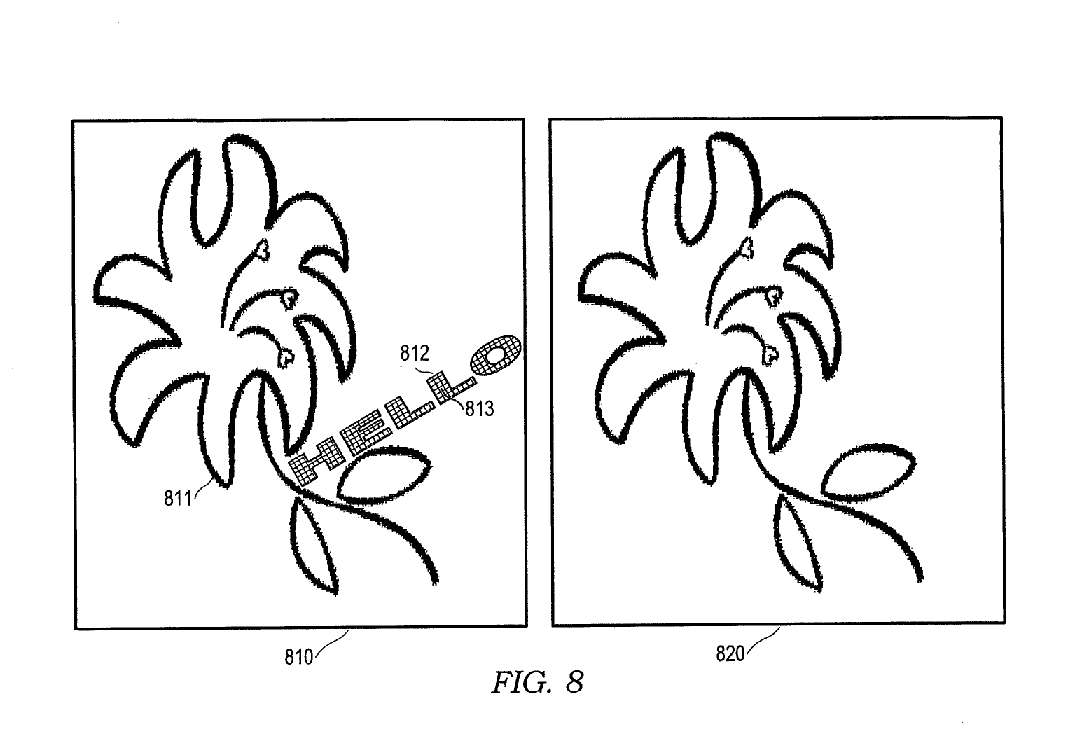

FIG. 8 schematically illustrates a frame 810 as displayed on primary display unit 110 or 210, and a modified frame 820 as displayed substantially simultaneously on secondary display unit 120 or 220, demonstrating the operation of an “texture filtering” video modification in accordance with some embodiments of the invention.

Frame 810 may include one or more portions of video content, for example, a flower 811 and an element 812 having a pre-defined property In some embodiments, for example, element 812 may include a text having a pre-defined font texture 813, a pre-defined font size, a pre-defined font color, a pre-defined unique texture or mixture of textures, or the like.

In some embodiments, frame 810 need not include an additional element to indicate that a “texture filtering”, but rather, the inclusion of the element 812 having the unique texture 813 may serve also as an indication that a “texture filtering” operation may be required.

An exemplary result of including the element 812 is shown in a frame 820 as displayed on secondary display unit 120 or 220. Frame 820 includes flower 811, but does not include element 812.

In some embodiments, recognition unit 313 may analyze the frame 810 and may identify that it includes element 812 having the pre-defined unique texture 813. Upon identifying these elements, recognition unit 313 may send a control signal to processing unit 314. The control signal may indicate, for example, that a “texture filtering” instruction is embedded within frame 820, as well as values of one or more parameters which may be used by processing unit 314 to perform the “texture filtering” instruction. For example, the control signal may indicate the location of substantially all areas, pixels or elements having the unique texture 813. Such areas, pixels or elements may be modified by modification unit 314, for example, by filling them with a pre-defined color, e.g., a white color, a black color, a color similar or identical to the background color of frame 810, a color similar or identical to the most common color of frame 810, a textual or graphical object indicating that a portion of frame 820 was removed, or the like.

In some embodiments, frame 810 may include an optional element, which may be similar to element 841, indicating that frame 810 includes a “texture filtering” instructions. In one embodiment, this may allow, for example, a faster recognition process by recognition unit 314, for example, e.g., if the optional element is placed in a pre-defined location of frame 314 and recognition unit 314 analyzes that pre-defined location in search for the optional element, instead of searching the entire frame 810 for the element 812 having the unique texture. Similarly, other suitable numbers of elements or groups of elements may be used to indicate that “texture filtering” is required, or to indicate values of one or more properties which may be used in the modification process.

In some embodiments, one or more of the elements used for indicating a “texture filtering” instructions may include, for example, data indicating one or more properties to be used when the instruction is performed, e.g., data indicating a color-related attribute, a background color attribute, a foreground color attribute, a time-related attribute, or other suitable properties related to the modification.

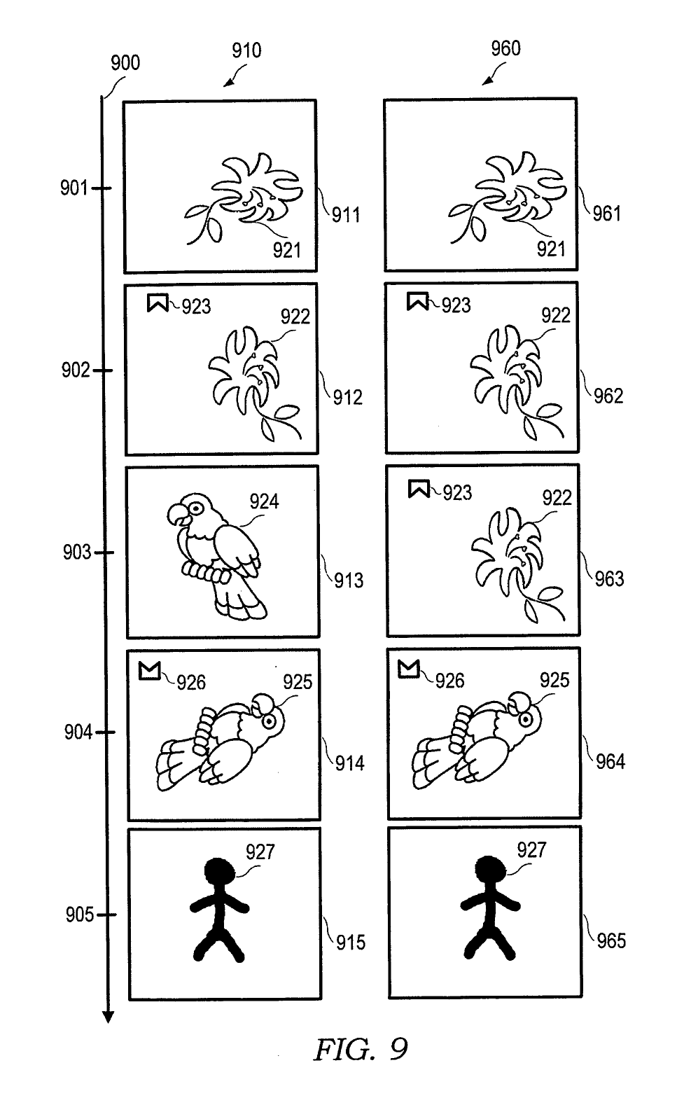

FIG. 9 schematically illustrates a series of consecutive frames 910 as displayed on primary display unit 110 or 210, and a series of consecutive modified frames 960 as displayed substantially simultaneously on secondary display unit 120 or 220, demonstrating the operation of a “freeze” video modification in relation to a timeline 900, in accordance with some embodiments of the invention.

As indicated at timeline 900, at time-point 901, a frame 911 may be displayed on primary display unit 110 or 210, and a substantially identical frame 961 may be displayed on secondary display unit 120 or 220. Frames 911 and 961 may include substantially identical video content, e.g., a flower 921. It is noted that frame 911 may not include an element indicating a “freeze” instruction.

At time-point 902, a frame 912 may be displayed on primary display unit 110 or 210, and a substantially identical frame 962 may be displayed on secondary display unit 120 or 220. Frames 912 and 962 may include substantially identical video content, e.g., a flower 922. It is noted that frame 912 may include an element 923 indicating a “freeze” instruction, which may also be displayed in frame 962. In some embodiments, element 923 may indicate that the content displayed in frame 962 should be continuously displayed on secondary display unit 120 or 220, regardless of changing content displayed on primary display unit 110 or 210, until another element is identified indicating a “de-freeze” instruction.

At time-point 903, a frame 913 may be displayed on primary display unit 110 or 210, and a frame 963 may be displayed on secondary display unit 120 or 220. Frame 913 may include a video content, for example, a bird 924. Since frame 913 may not include an element indicating a “de-freeze” instruction, frame 963 may be substantially identical to frame 962, e.g., frame 963 may include the flower 922 of frame 962. In one embodiment, frame 963 may include the element 923, although in an alternate embodiment element 923 may be removed and may not appear in frame 963.

At time-point 904, a frame 914 may be displayed on primary display unit 110 or 210, and a frame 964 may be displayed on secondary display unit 120 or 220. Frame 914 may include a video content, e.g., a bird 925, and an element 926 indicating a “de-freeze” instruction. Frame 964 may be substantially identical to frame 914, for example, frame 914 may also include bird 925 and element 926. In some embodiments, element 926 may indicate that a previous “freeze” operation, which previously resulted in a non-changing on display unit 120 or 220, be terminated such that secondary display unit 120 or 220 may be again in synchronization with primary display unit 110 or 210.

As indicated at timeline 905, at time-point 905, a frame 915 may be displayed on primary display unit 110 or 210, and a substantially identical frame 965 may be displayed on secondary display unit 120 or 220. Since the previous “freeze” instruction of frame 912 was terminated by the previous “de-freeze” instruction of frame 914, the result may be that frames 915 and 965 may include substantially identical video content, e.g., a person 927.

Although element 923 may be used to indicate a “freeze” instruction and element 926 may be used to indicate a “de-freeze” instruction, the present invention is not limited in this regard, and other suitable numbers of elements or groups of elements may be used. For example, in some embodiment, a single element may be used to indicate that a “freeze” instruction may begin and may be carried out for a pre-defined period of time, e.g., for thirty seconds, or for a pre-defined number of frames, e.g., 600 frames In some embodiments, one or more of the elements used to indicate a “freeze” instruction and/or a “de-freeze” instruction, may include, for example, data indicating one or more properties to be used when the instruction is performed, e.g., data indicating a color-related attribute, a background color attribute, a foreground color attribute, a time-related attribute, or other suitable properties related to the modification.

In some embodiments, element 923 and/or 926 may be positioned at a pre-determined location in frames 912 and/or 914, respectively. This may allow, for example, a relatively faster recognition of elements 923 and/or 926 by recognition unit 313.

In some embodiments, one or more video modification operations may be used in combination. For example, a video frame may include one or more elements indicating an “area of interest” instruction, an “area hide-out” instruction, an “area blowout” instruction, a “texture filtering” instruction, a “freeze” instruction and/or a “de-freeze” instruction, as well as other instructions in accordance with embodiments of the invention.

In some embodiments, a pre-defined modification order may be used, for example, to define an order in which a combination of modification codes are recognized and/or an processed. Some embodiments may, for example, process an element indicating an “area hide-out” code and then process an element indicating a “freeze” code.

In some embodiments, an element may indicate one or more image rendering codes. For example, a first pre-defined element may indicate both a “freeze” instruction and an “area blowout” instruction, and a second pre-defined element may indicate both a “de-freeze” instruction and an “area of interest” instruction.

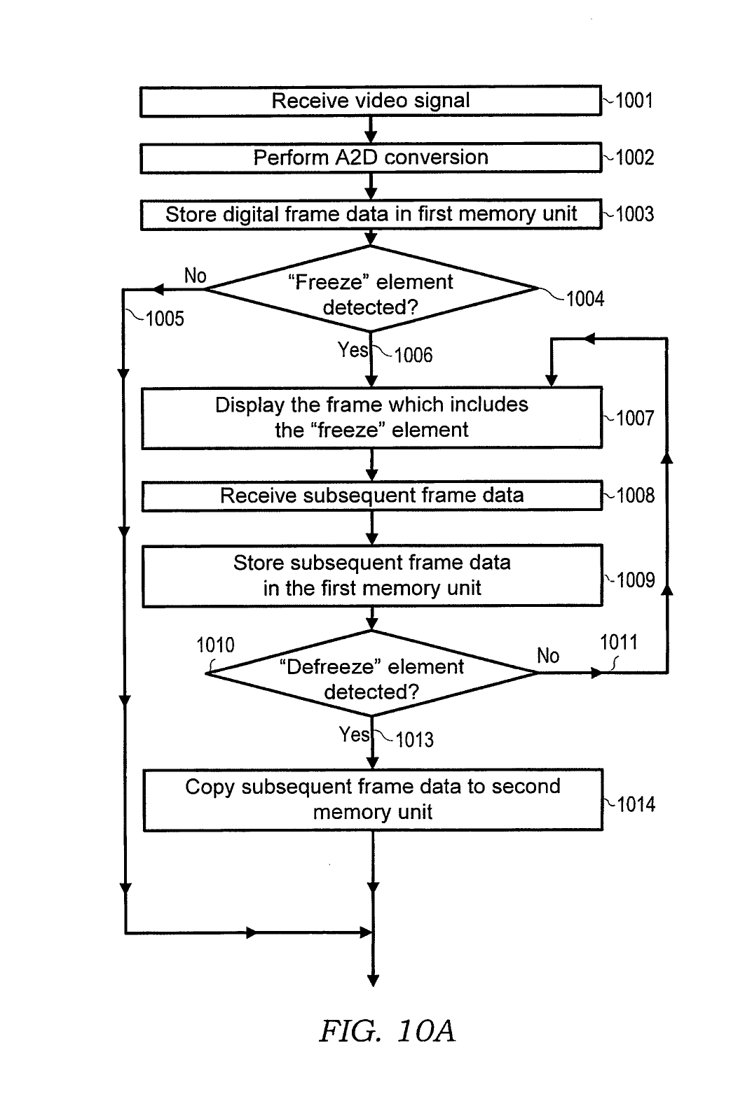

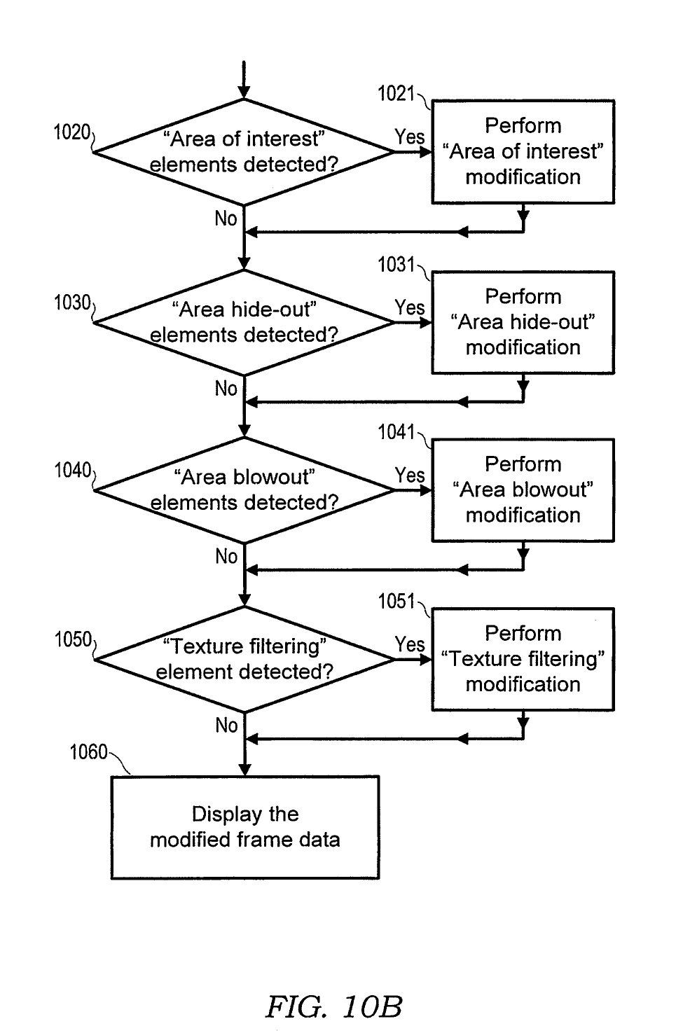

Reference is now made to FIGS. 10A-10B, which are a schematic flow-chart of a method of video modification in accordance with some embodiments of the invention. The method may be used, for example, by video adaptor 300, by processing circuit 310, by video adaptor 250, by video adaptor 150, or by other suitable devices or systems. The method of FIGS. 10A-10B may be a more detailed implementation of the operations indicated by blocks 404-407 of FIG. 4, and may demonstrate, for example, video modification in accordance with a combination of elements indicating a plurality of image rendering codes.

As indicated at block 1001, the method may include receiving an incoming video signal, e.g., by video adaptor 300. As indicated at block 1002, the method may include performing A/D conversion, e.g., by A/D converter 315, thereby producing digital frame data. As indicated at block 1003, the method may include storing the digital frame data in a first memory unit, e.g., memory unit 311.

As indicated at block 1004, the method may include analyzing the digital frame data to determine whether it includes an element indicating a “freeze” instruction. As indicated by arrow 1005, if an element indicating a “freeze” instruction is not detected, than the method may proceed with the operations indicated at block 1020 and onward.

In contrast, as indicated by arrow 1006, if an element indicating a “freeze” instruction is detected, then, as indicated at blocks 1007-1014, the method may include performing a “freeze” sub-process. For example, as indicated at block 1007, the method may include continuously displaying the frame which included the element indicating the “freeze” instruction. This may be performed, for example, by copying the content of the first memory unit 311 to a second memory unit, e.g., memory unit 312, whose content may be transferred out for display. As indicated at block 1008, the method may include receiving a subsequent frame data, and, as indicated at block 1009, storing the subsequent frame data in the first memory unit 311. As indicated at block 1010, the method may include analyzing the subsequent frame data to determine whether it includes an element indicating a “de-freeze” instruction. If an element indicating a “de-freeze” instruction is not detected, then, as indicated by arrow 1011 which leads to block 1007, the method may include maintaining the previous content of the second memory unit 312 and similarly receiving and analyzing subsequent frames. If an element indicating a “de-freeze” instruction is detected, then, as indicated by arrow 1013 which leads to block 1014, the method may include displaying the subsequent frame, or copying the subsequent frame data from the first memory unit 311 to the second memory unit 312 for display and/or for further modifications. Other sets of operations may be used to maintain a current display which includes an element indicating a “freeze” instruction, and to avoid displaying subsequent frames until a subsequent frame is received which includes an element indicating a “de-freeze” instructions.

If a “freeze” sub-process did not take place or was completed, then, as indicated at block 1020, the method may include analyzing the frame to detect one or more elements indicating an “area of interest” instruction, and upon such detection, as indicated at block 1021, performing the “area of interest” video modification.

As indicated at block 1030, the method may include analyzing the frame to detect one or more elements indicating an “area hide-out” instruction, and upon such detection, as indicated at block 1031, performing the “area hide-out” video modification.

As indicated at block 1040, the method may include analyzing the frame to detect one or more elements indicating an “area blowout” instruction, and upon such detection, as indicated at block 1041, performing the “area blowout” video modification.

As indicated at block 1050, the method may include analyzing the frame to detect one or more elements indicating a “texture filtering” instruction, and upon such detection, as indicated at block 1051, performing the “texture filtering” video modification.

As indicated at block 1060, the method may include displaying the modified frame. This may include, for example, storing or copying the modified frame data to the second memory unit 312. It will be appreciated that in some embodiments, the method may include various other suitable operations, for example, frame analysis to detect one or more elements indicating other suitable image rendering codes, followed by performing pre-defined operations in accordance with the detected elements. It is noted that elements may be recognized and/or handled in any suitable order, and not necessarily in the order shown in FIGS. 10A-10B.

Other suitable operations or sets of operations may be used in accordance with embodiments of the invention.

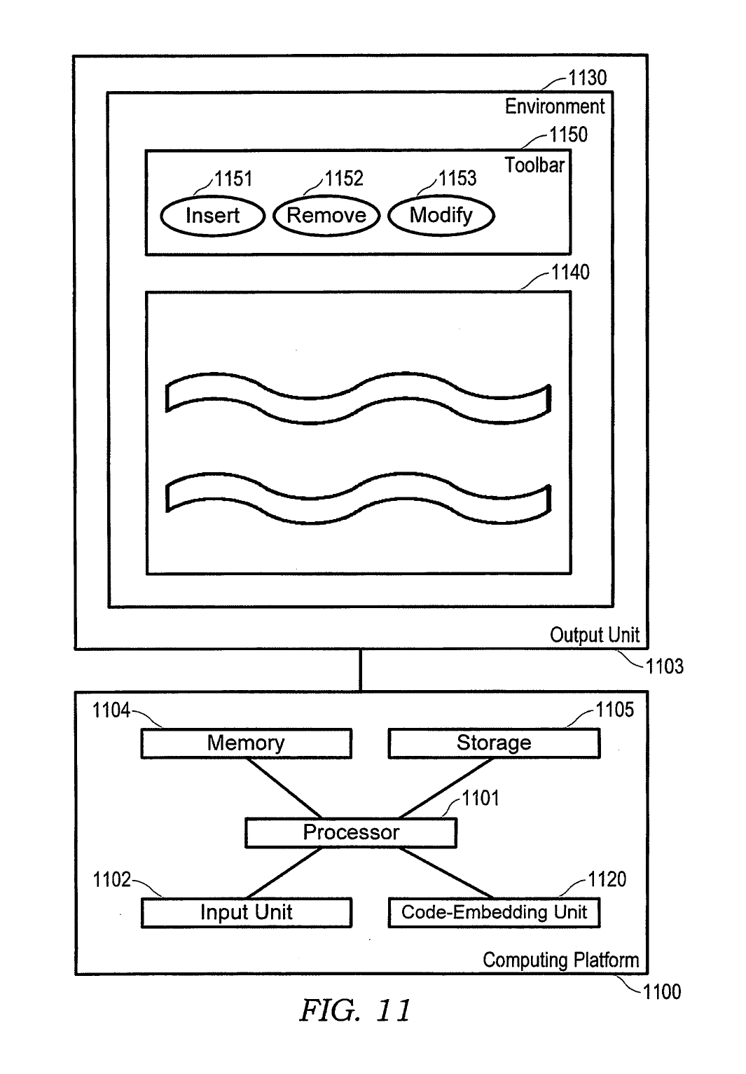

FIG. 11 schematically illustrates a computing platform 1100 able to generate an enhanced video signal in accordance with some embodiments of the invention. Computing platform 1100 may be an example of computer 140 and/or computer 240.

Computer 1100 may include, for example, a processor 1101, an input unit 1102, an output unit 1103, a memory unit 1104, and a storage unit 1105. Computing platform 1100 may additionally include other suitable hardware components and/or software components. In some embodiments, computing platform 1100 may include or may be, for example, a personal computer, a desktop computer, a mobile computer, a laptop computer, a notebook computer, a terminal, a workstation, a server computer, a Personal Digital Assistant (PDA) device, a tablet computer, a network device, or other suitable computing device.

Processor 1101 may include, for example, a Central Processing Unit (CPU), a Digital Signal Processor (DSP), a microprocessor, a plurality of processors, a controller, a chip, a microchip, or any other suitable multi-purpose or specific processor or controller.

Input unit 1102 may include, for example, a keyboard, a mouse, a touch-pad, or other suitable pointing device or input device. Output unit 1103 may include, for example, a Cathode Ray Tube (CRT) monitor, a Liquid Crystal Display (LCD) monitor, or other suitable monitor or display unit.

Storage unit 1105 may include, for example, a hard disk drive, a floppy disk drive, a Compact Disk (CD) drive, a CD-Recordable (CD-R) drive, or other suitable removable and/or fixed storage unit. Memory unit 1104 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units. Computing platform may further include one or more software applications, for example, an application to produce a presentation or a document, e.g., similar to Microsoft (RTM) Word (RTM) or Microsoft (RTM) PowerPoint (RTM) applications. The software applications may be executed by processor 1101, thereby displaying an editing environment 1130 on or through output unit 1103. Environment 1130 may include, for example an editable area 1140 and a toolbar 1150. A user may use, for example, input unit 1102 and/or toolbar 1150 to interactively create and/or modify content which may appear in editable area 1140.

Toolbar 1150 may include an interface for inserting, removing and/or modifying elements indicating image rendering codes in accordance with embodiments of the invention. For example, toolbar 1150 may include a clickable “insert” (or “embed”) button 1151, allowing the user to insert into editable area 1140 a new element indicating an image rendering code by clicking or otherwise selecting the “insert” button 1151. In one embodiment, for example, a plurality of “insert” buttons 1151 may be used to allow insertion of a plurality of elements, respectively. In an alternate embodiment, an “insert” button 1151 may be used in association with a drop-down menu, thereby allowing the user to select an element from a pre-defined list.

Toolbar 1150 may include other suitable buttons, for example, a button 1152 for removing a previously-inserted element from editable area 1140, or a button 1153 for modifying a property of a previously-inserted element, e.g., for changing the location of a previously-inserted element in editable area 1140, or for changing the dimensions of an area associated with a previously-inserted element in editable area 1140.

Although a toolbar 1150 and a graphical environment 1130 is shown, embodiments of the present invention are not limited in this regard, and may include, for example, a textual user interface, a graphical user interface, a drag-and-drop user interface, buttons, menus, or the like. In some embodiments, instructions to insert, remove or modify elements representing image rendering codes, may be performed by a code-embedding unit 1120. In some embodiments, code-embedding unit 1120 may be implemented as a software module, e.g., which may be executed by processor 1101, stored in memory unit 1104 or storage unit 1105. In alternate embodiments, code-embedding unit may include software components, hardware components, or a suitable combination of hardware and software components. Code-embedding unit may, for example, modify data representing a content displayed by output unit 1103, such that the data may include data representing one or more elements corresponding to image rendering codes.

Although part of the discussion herein may relate, for exemplary purposes, to modifications related to “area of interest”, “area hide-out”, “area blowout”, “texture filtering”, “freeze” and/or “de-freeze”, embodiments of the invention are not limited in this regard. Some embodiments may include various other types of modifications, for example, modifying a color of a selected area, modifying a font of a selected text or area, modifying a size of a selected area, blurring a selected area, blurring a content external to a selected area, emphasizing a selected area, emphasizing a content external to a selected area, creating a blinking or flashing effect in a selected area, turning on or turning off or toggling a “bold” property of a text or an area, turning on or turning off or toggling an “underline” property of a text or an area, turning on or turning off or toggling an “italics” property of a text or an area, modifying a size of a font, animating or moving or de-animating a selected area or object, or the like.

Although part of the discussion herein may relate, for exemplary purposes, to a digital signal carrying an element indicating a modification instruction, embodiments of the invention are not limited in this regard, and may be used, for example, in conjunction with an analog video signal carrying data indicating a modification instruction, and performing of modifications based on one or more elements or instructions included in the analog video signal.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, storage units and/or memory units, for temporary or long-term storage of data or in order to facilitate the operation of a specific embodiment.

Some embodiments of the invention may be implemented, for example, using a machine-readable medium or article which may store an instruction or a set of instructions that, if executed by a machine, for example, by video adaptor 150, by compute 140, by video adaptor 250, by computer 240, by video adaptor 300, by computing platform 1100, or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software The machine-readable medium or article may include, for example, any suitable type of memory unit (e.g., memory units 311, 312 or 1104), memory device, memory article, memory medium, storage device, storage article, storage medium and/or storage unit (e.g., storage unit 1105), for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1. A device comprising:
an adaptor to receive a first video signal having an image rendering code embedded therein, and to produce a second video signal based on said first video signal and said image rendering code.

2. The device of claim 1, wherein said image rendering code corresponds to an element selected from a group including a graphical element and a textual element.

3. The device of claim 1, wherein said first and second video signals are in accordance with a three-primary-colors standard.

4. The device of claim 1, comprising:
an Analog to Digital converter to convert said first video signal from an analog format to a digital format; and
a Digital to Analog converter to convert said second video signal from a digital format to an analog format.

5. The device of claim 1, comprising a recognition unit to recognize said image rendering code.

6. The device of claim 1, comprising a modification unit to modify said first video signal based on said image rendering code.

7. The device of claim 1, wherein said image rendering code defines an area of interest selected from a group including an area of interest to be removed and an area of interest to be maintained.

8. The device of claim 1, wherein said image rendering code defines an area of interest selected from a group including an area of interest to be enlarged and an area of interest to be reduced.

9. The device of claim 1, wherein said image rendering code defines a texture to be removed.

10. The device of claim 1, wherein said image rendering code is selected from a group including an element indicating a beginning of a freeze-screen process and an element indicating an ending of a freeze-screen process.

11. The device of claim 1, comprising:
an input socket to receive said first video signal; and
an output socket to transfer said second video signal.

12. The device of claim 11, comprising another output socket able to transfer a video signal substantially identical to said first video signal.

13. A computing platform comprising:
a code-embedding unit to embed an image rendering code in a video signal.

14. The computing platform of claim 13, wherein said image rendering code corresponds to an element selected from a group including a graphical element and a textual element.

15. The computing platform of claim 13, wherein said video signal comprises a video signal in accordance with a three-primary-colors standard.

16. The computing platform of claim 13, wherein said image rendering code defines an area of interest selected from a group including an area of interest to be removed and an area of interest to be maintained.

17. The computing platform of claim 13, wherein said image rendering code defines an area of interest selected from a group including an area of interest to be enlarged and an area of interest to be reduced.

18. The computing platform of claim 13, wherein said image rendering code defines a texture to be removed.

19. The computing platform of claim 13, wherein said image rendering code is selected from a group including an element indicating a beginning of a freeze-screen process and an element indicating an ending of a freeze-screen process.

20. A method comprising:
receiving a first video signal having one or more image rendering codes embedded therein; and
producing a second video signal based on said first video signal and said one or more image rendering codes.

21. The method of claim 20, comprising:
searching for said one or more image rendering codes included in said first video signal.

22. The method of claim 20, comprising:
modifying at least a portion of a video frame carried by said first video signal based on said one or more image rendering codes.

23. A machine-readable medium having stored thereon instructions that, if executed by a machine, cause the machine to perform a method comprising:
receiving a first video signal having one or more image rendering codes embedded therein; and
producing a second video signal based on said first video signal and said one or more image rendering codes.

24. The machine-readable medium of claim 23, wherein the instructions cause the machine to perform a method comprising:
searching for said one or more image rendering codes included in said first video signal.

25. The machine-readable medium of claim 23, wherein the instructions cause the machine to perform a method comprising:
modifying at least a portion of a video frame carried by said first video signal based on said one or more image rendering codes.
